(19) United States
(12) Patent Application Publication
(10) Pub. No.: US 2014/0326716 A1
(43) Pub. Date: Nov. 6, 2014

(54) POWER CABLE CONNECTION ASSEMBLY AND METHOD OF OPERATION

(71) Applicant: I SQ. R POWER CABLE CO., Canton, OH (US)

(72) Inventors: Karl J. Schwenk, Canton, OH (US); Michael Gustav Pinney, Canton, OH (US); Dominic Musisca, Uniontown, OH (US)

(73) Assignee: I SQ. R POWER CABLE CO., Canton, OH (US)

(21) Appl. No.: 14/268,534

(22) Filed: May 2, 2014

Related U.S. Application Data
(60) Provisional application No. 61/819,205, filed on May 3, 2013.

(51) Int. Cl. H05B 6/04; H01R 13/52

(52) U.S. Cl. CPC H05B 6/04; H01R 13/52
USPC 219/632; 439/271; 29/825

(57) ABSTRACT

A quick disconnect union and method of use is provided for a power cable of an induction heating system with a power source, a coolant transporting device, and an induction coil capable heating a desired material. The power cable may connect the power source and the coolant transporting device to the induction coil.

### CROSS-REFERENCE TO RELATED APPLICATION

This application claims priority from U.S. Provisional Application Ser. No. 61/819,205, filed May 3, 2013, the disclosure of which is incorporated herein by reference.

### BACKGROUND OF THE INVENTION

1. Technical Field

The present invention relates to connection members. More particularly, the invention relates to a power cable quick disconnect union. Specifically, a quick disconnect brass union is provided that is adapted for use with an induction heater and capable of cooling the electrical wires and coils that carry power to the induction heater.

2. Background Information

An induction coil is a type of disruptive charge coil. It is a coil carrying high-frequency alternating current (AC), producing eddy currents to heat objects placed in the interior of the coil, in induction heating or zone melting equipment.

Ordinarily, an induction coil heater includes an electromagnet, through which a high-frequency alternating current (AC) may be passed. Heat may also be generated by magnetic hysteresis losses in materials that have significant relative permeability. The frequency of AC used depends on the object size, material type, coupling (between the work coil and the object to be heated) and the penetration depth.

Induction heating allows the targeted heating of an applicable item for applications including surface hardening, melting, brazing and soldering and heating to fit. Iron and its alloys respond best to induction heating, due to their ferromagnetic nature.

Induction heaters are often large systems comprising various electrical and cooling components. Copper or brass wires often form the induction coils that carry the current which heats the desired metal.

The large and often complex induction heating systems have components which naturally require repair or inspection after extended use. However, many laborers have difficulty in disassembling the complex induction heaters to either replace or inspect the working components.

Thus there exists a need for an improved way to connect the elements of an induction heating system.

### BRIEF SUMMARY OF THE INVENTION

Briefly, in one aspect, the invention may provide an induction heating system comprising an electrical power source, a coolant transporting device, an induction coil, a power cable connecting the power source and the coolant transporting device to the induction coil, and at least one quick disconnect union operatively connected to the power cable and one of the power source, the coolant transporting device and the induction coil.

Further, another aspect of the invention may provide a quick connect and disconnect union comprising a female member defining an inner cavity, a male member comprising an extending member defining an annular recess and a compressible gasket in the annular recess, configured to mate with the female member, wherein the gasket seals the female and male members together, a securing member having a secured position and an unsecured position and adapted to secure the female and male members together in a mated position, a union lumen defined by the mated female and male members, and wherein the union is adapted to secure a power cable comprising electrical wires, coolant, and a crimp terminal, to one of (a) a power source, (b) a coolant transporting device, and (c) an induction heating apparatus.

In another aspect, the invention may provide comprising the steps of providing an induction heating system comprising a power source, a coolant transporting device, an induction coil, a power cable connecting the power source and the coolant transporting device to the induction coil, a quick disconnect union which comprises a female member, a male member, and a securing member, inserting the male member into the female member, creating a seal between a gasket and an inner surface of the female member, and securing the male and female members together with the securing member to secure the power cable to one of (a) the power source, (b) the coolant transporting device, and (c) the induction coil.

### BRIEF DESCRIPTION OF THE SEVERAL VIEWS OF THE DRAWINGS

Preferred embodiments of the invention, illustrated of the best mode in which Applicant contemplates applying the principles, are set forth in the following description and are shown in the drawings and are particularly and distinctly pointed out and set forth in the appended claims.

FIG. 1 is a schematic view of the induction coil heating system.

FIG. 2 is an isometric perspective view showing an assembled union with portions cut away.

FIG. 3 is an exploded isometric view of the union.

FIG. 4 is a longitudinal cross section view of a disconnected union

FIG. 4A is a longitudinal cross section view of a connected union.

FIG. 5 is a cross sectional view along section 5 of FIG. 4.

FIG. 6 is a cross section view along section 5 of FIG. 4 showing an alternative embodiment of the securing member.

FIG. 6A is a plan view of an alternative embodiment of the securing member.

Similar numbers refer to similar parts throughout the drawings.

### DETAILED DESCRIPTION OF THE INVENTION

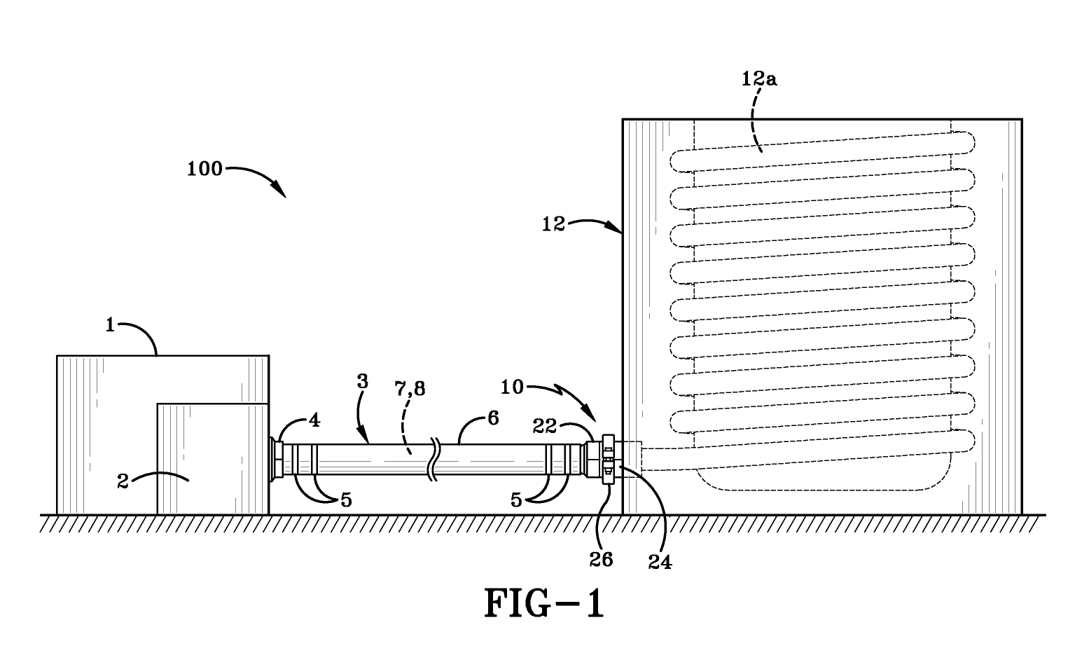

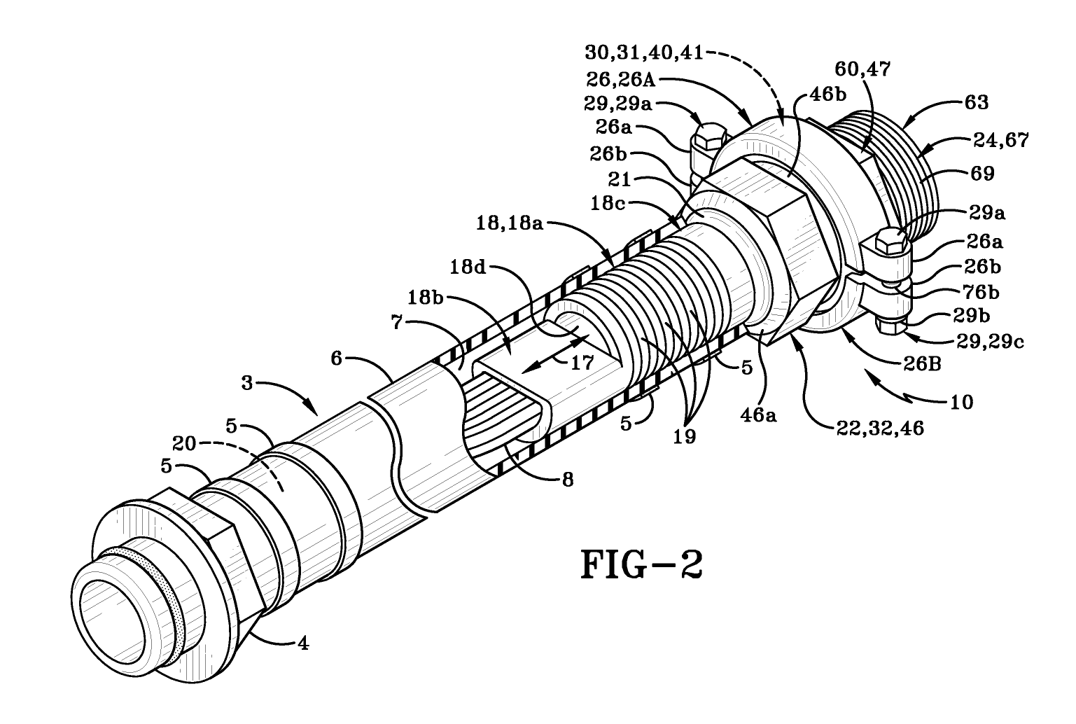

With primary reference to FIG. 1, the induction heating system 100 has an electrical power source 1 and a coolant-transporting device 2, operatively connected to a power cable 3 by a connecting member 4. Power cable 3, having two ends, operatively connects to a quick disconnect union 10 at the end opposite connecting member 4. Quick disconnect union 10 operatively connects power cable 3 to a heating device 12. Heating device 12 comprises a fluid cooled induction coil 12a. Power cable 3 comprises hose clamps 5, an electrically nonconductive tubular hose 6 defining a hose lumen 7. An array of wires 8 are housed within the lumen 7. Hose clamps 5 secure one end of the hose 6 to connecting member 4 and the other end of the hose to the union 10. Generally, the quick disconnect union 10 comprises a first or female member 22, a second or male member 24 adapted to mate with female member 22, and a securing member 26 to secure the female and male members 22, 24 together when mated.

Power source 1 can be any conventionally known electrical power source in the art. The coolant transportation device 2 can be any conventionally known device known in the art cable of moving a fluid for one point to another. Preferably, coolant transportation device 2 is a pump. Coolant in the system flows along directional arrow 17 within the hose lumen 7. The induction coil 12a is a conventionally known type ordinarily used to create molten metal through a super heating process. The induction coil 12a can be adapted to heat a plurality of known containers, such as a smelter. Other uses that require heating a product to a temperature higher than what may be output by conventional residential heating units may be adapted to receive and be heated by the induction coil 12a.

With primary reference to FIG. 2, the union 10 comprises female member 22, male member 24, securing member 26, crimp terminal 18, and tightening member 29. Male member 24 has a continuous outer surface 60 and a continuous inner surface 61. A threaded surface 67, having threads 69, extends for a distance towards a proximal end of male member 24. A male hexagonal surface 47 extends proximally from the threaded surface 67. A male flange 41 taperedly extends proximally from the hexagonal surface 47. Preferably, a distal end 63 of male member 24 is adjacent the heating device 12.

The female member 22 has a continuous outer surface 32. A female flange 40 connects to the male flange 41 when the two members 22, 24 are selectively mated. A smooth surface 46b extends distally from the flange 40. A female hexagonal surface 46 is attached to the smooth surface 46b and extends distally from the smooth surface 46. A female chamfered surface 46a is attached to the hexagonal surface 46 and extends distally from the hexagonal surface 46. A terminal seat 37 is attached to the chamfered surface 46a and extends distally from the chamfered surface 46a.

When female and male members 22, 24 are selectively mated, the female and male flanges 40, 41 create a tongue 30. The tongue 30 may be releasably secured by securing member 26 defining a groove 31. Securing member 26 comprises a first member 26A and a second member 26B. Each member 26A, 26B is generally semi-circular. At least one first boss 26a extends from an end of first member 26A. First boss 26a defines a first tightening member aperture 76a.At least one second boss 26b extends from an end of second member 26B. Second boss 26b defines a second tightening member aperture 76b. The first and second tightening member apertures 76a, 76b are aligned and receive a tightening member 29. Preferably, tightening member 29 comprises a bolt 29a, a lock washer 29b, and a nut 29c. The bolt 29a is inserted through the aligned apertures 76a, 76b, and then the lock washer 29b and nut 29c engage the bolt in a conventional manner.

A crimp terminal 18 connects to a terminal seat 37 of female member 22. Preferably, crimp terminal 18 is silver brazed or soldered 21 to female member 22; however, other ways of connection as would be understood in the art are contemplated. The crimp terminal comprises a wire retaining surface 18a, a crimp surface 18b, and a crimp seat 18c, and a crimp aperture 18d. The retaining surface 18a is located between the crimp surface 18b and the crimp seat 18c.

The crimp terminal 18 secures wires 8 to the union 10. Preferably, wires 8 engage crimp terminal 18 at its crimp surface 18b. Crimp surface 18b may be crimped to secure wires 8. When crimped, crimp terminal 18 defines a crimp aperture 18d in fluid communication with the crimp lumen 18d. The crimp aperture 18d permits coolant to flow through the crimp terminal 18. The coolant cools the terminal as electricity is conducted through it. Crimp retaining surface 18a comprises a plurality of annular barbs 19. Annular barbs 19 engage the inner surfaces of the hose 6 to prevent the hose 6 from retracting from the crimp terminal 18. Further, the annular barbs' 19 engagement with the hose 6 creates a seal secured by hose clamps 5 to retain coolant within the hose lumen 7. While this embodiment provides a crimp terminal 18 connected to the union 10, it is to be understood that a second crimp terminal 20 located at the opposite end of power cable 3 may be similarly constructed and connected to member 4 to secure the opposite end of the hose 6 to either the power source 1 or the coolant transporting device 2. Hose 6 is preferably secured to the second crimp terminal 20 by hose clamp 5.

The coolant flow 17 within the system is a conventionally known type of coolant to one having ordinary skill in the art. The coolant flow 17 operates to reduce the temperature of the electrical cables 8 and the union 10 as electrical current is conducted through them. The coolant flows through lumen 16. Further, the coolant 17 may remain stagnant and operate as a passive coolant, or may be continually pumped in a conventionally known manner to act as an active coolant. The electrical wires 8 are wound, braided or spun in a conventional manner so as to efficiently and effectively conduct electrical current. Preferably the wires 8 are copper or brass, however other conventionally known conductive metals or alloys are contemplated and connected to the crimping terminal 18.

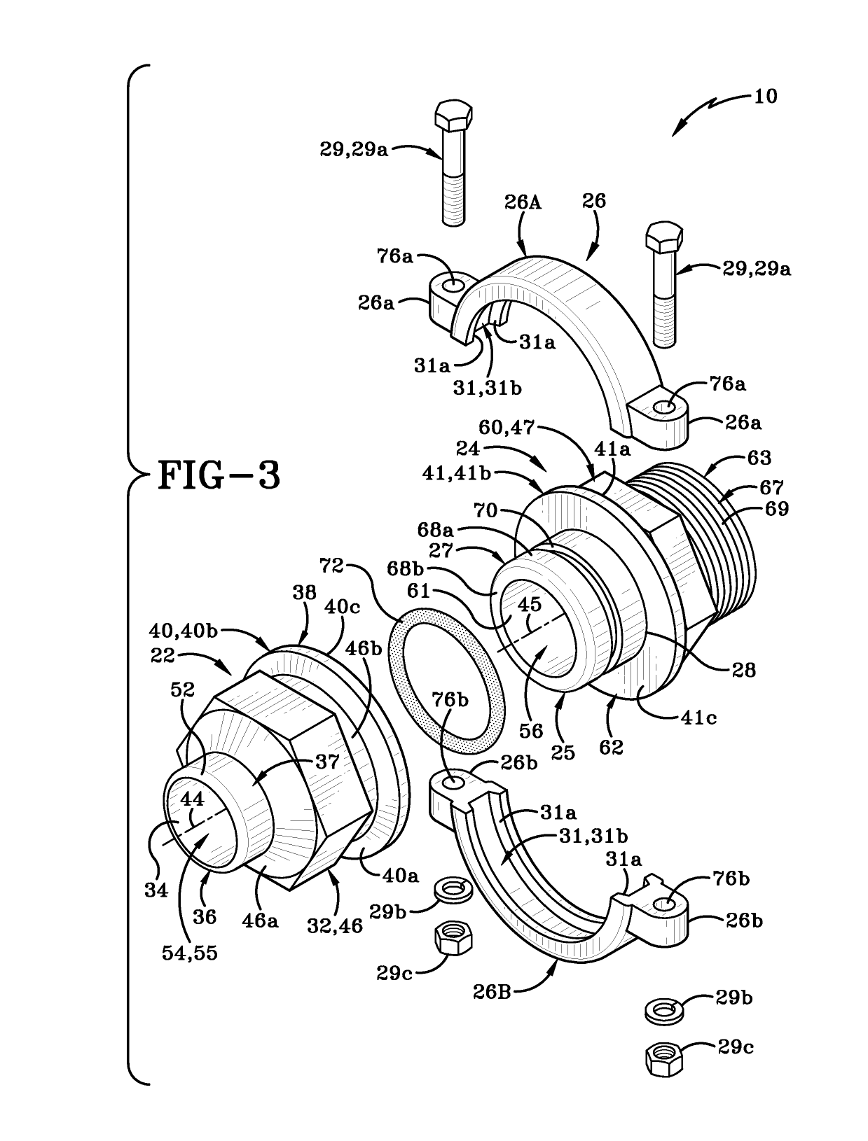

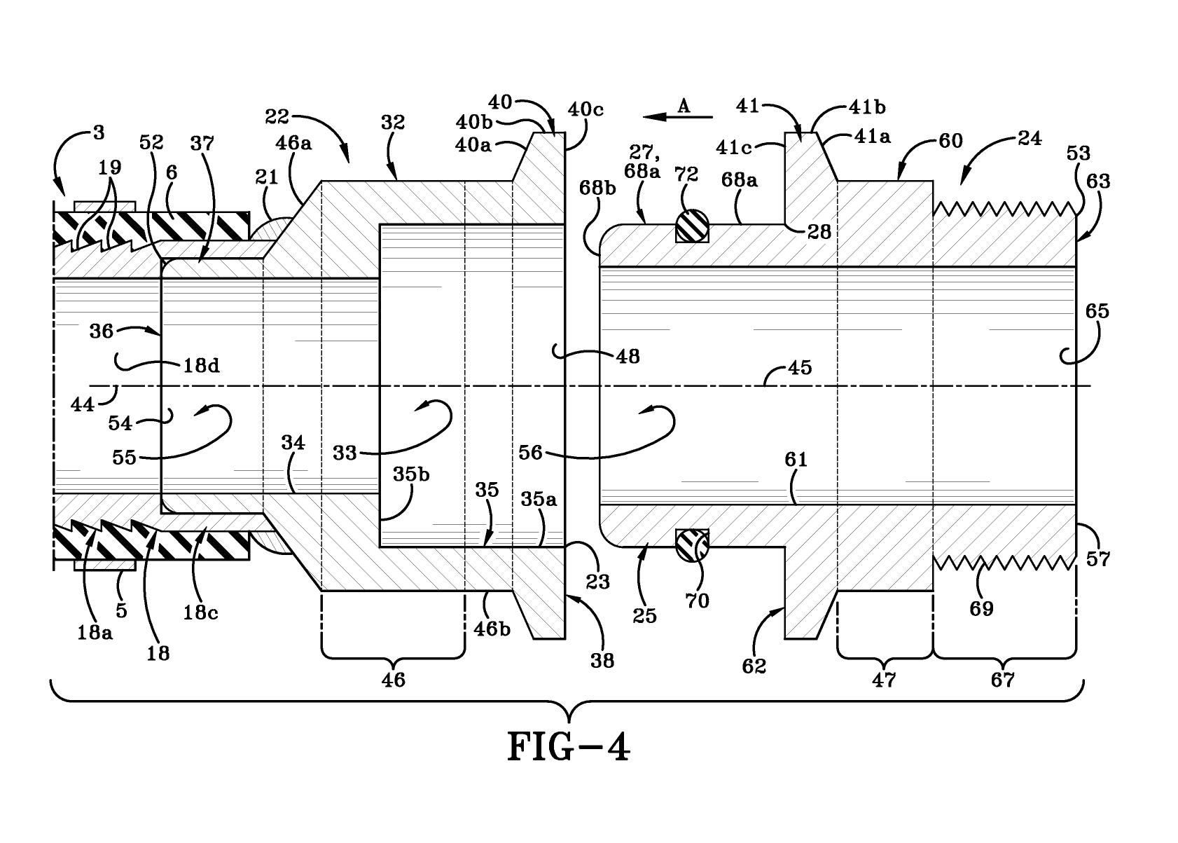

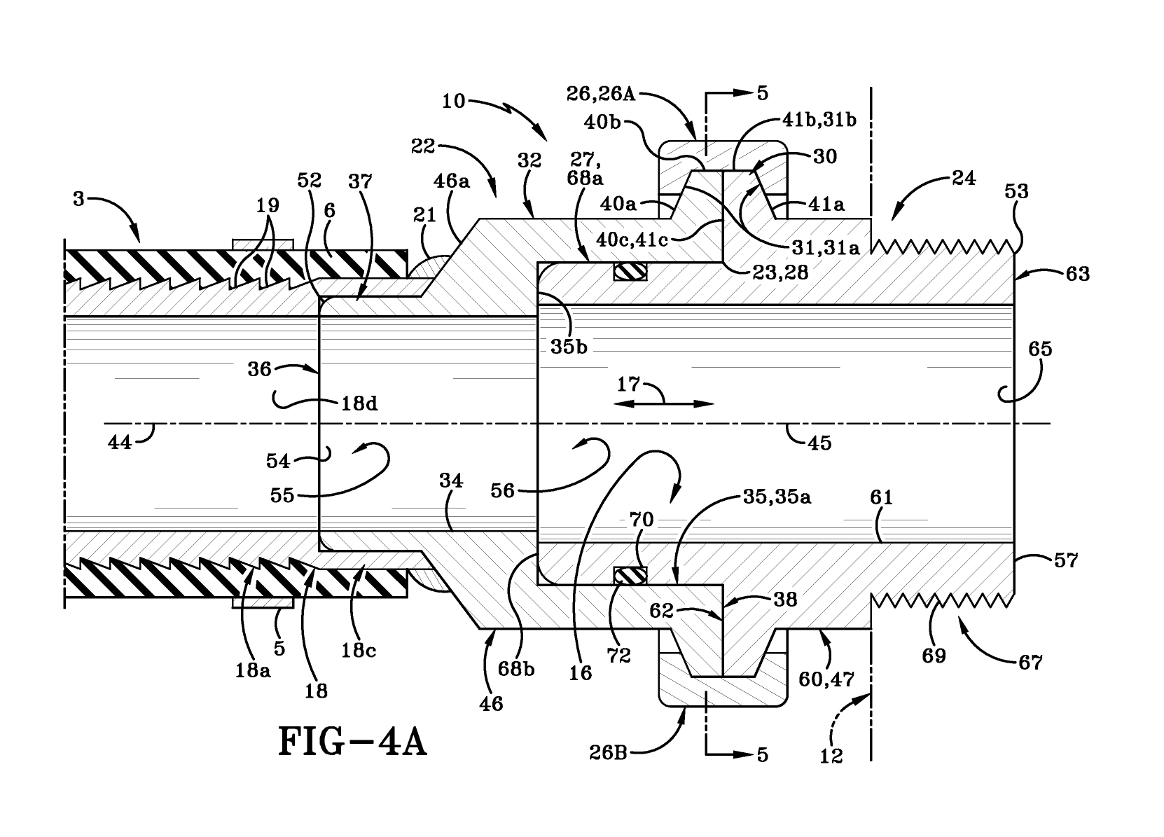

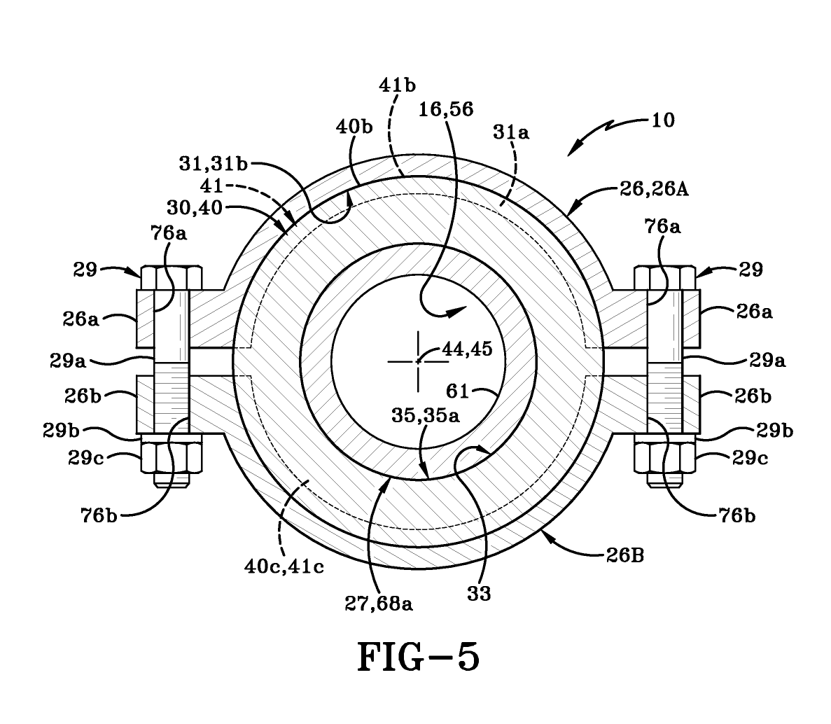

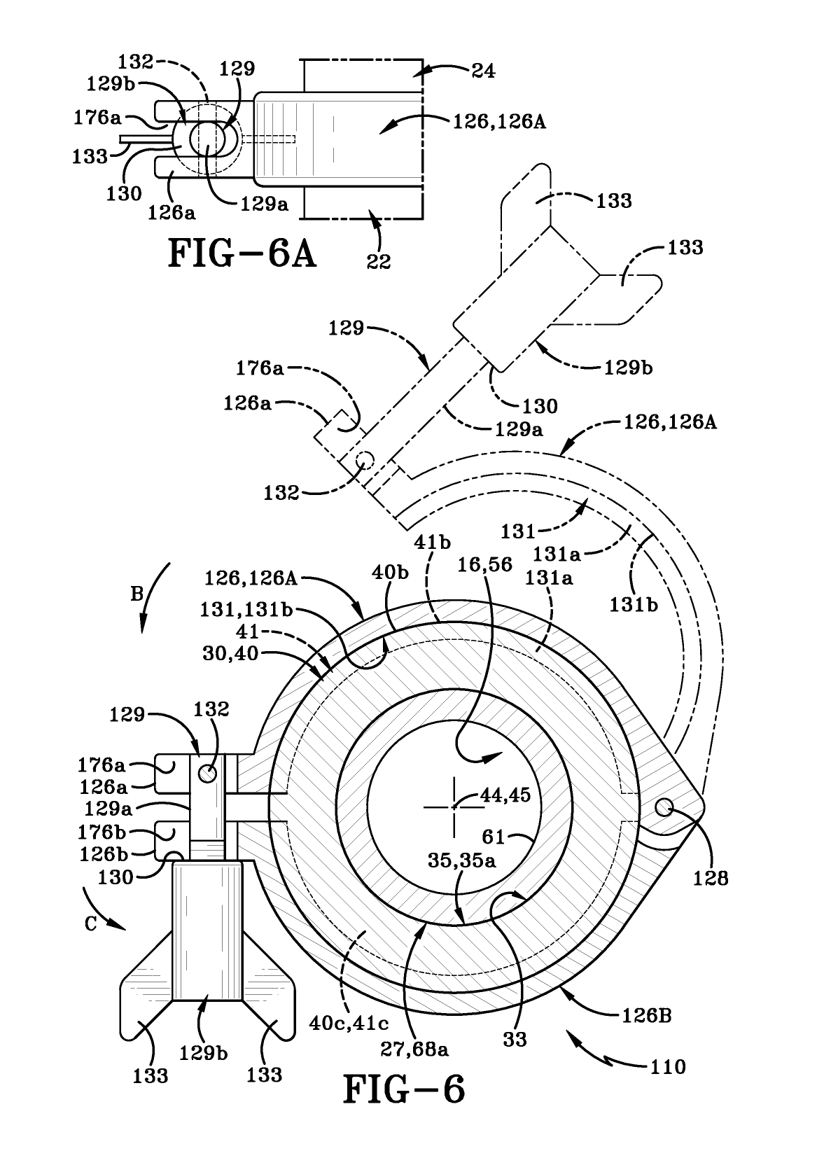

With primary reference FIGS. 3-6A, the quick disconnect union 10 is located between the induction coil 12 and the power source 11. The union 10 conducts electricity through the union body while permitting coolant to flow 17 through a union lumen 16 defined by the union 10. The union 10 is mostly made from an alloy capable of conducting electricity. The preferred alloy is brass, however other alloys as understand having ordinary skill in the art are acceptable. Further, while the union 10 is mostly made of alloys capable of conducting electricity, individual non-conductive components may be part of the union 10, such as the non-conductive compressible gasket 72. Further, the union 10 may be made by conventionally known process such as molding, forming, extruding, or similar ways to shape metal alloys to a desired shape. The female and male members 22, 24 mate with each other and additional similarly designed unions such that the members 22, 24 of the system 100 are interchangeable with another similar system. The securing member 26 seals the two members 22, 24 at their mating surface 27. The union lumen 16 is created by the alignment of a female lumen 55 and a male lumen 56 when the female and male members 22, 24 are mated. The union lumen 16 aligns with hose lumen 7 to permit coolant to flow 17 through the union 10.

Looking now to the female member 22, the female member 22 is generally cannular in shape. The generally cannular female member 22 has a continuous female outer surface 32 and a continuous female inner surface 34. The continuous female outer surface 32 is tapered at various intervals along the outer surface 32.

Further, the generally cannular female member 22 has a distal end 36 and a proximal end 38. The proximal end 38 is the end closest to the mating surface 27. The distal end 36 is farthest from the mating surface 27.

A female member flange 40 extends distally from the proximal end 38. Female flange 40 comprises an annular tapered surface 40a, an annular horizontal surface 40b, and a first vertical flange wall 40c. The first vertical flange wall 40c extends radially inward from the edge of the flange 40 towards a female longitudinal central axis 44. A smooth surface 46b extends distally from flange 40 as part of the outer surface 32 of the female member 22. A hexagonal surface 46 extends distally from the smooth surface 46b. The hexagonal surface 46 of the outer surface 32 is capable of receiving a conventional socket, wrench, or other known gripping member. Further, while the hexagonal surface 46 has a cross section of a conventional hexagon, other geometric cross sections that would provide a way for a gripping member to grasp the region are contemplated. A chamfered surface 46a extends distally from the hexagonal surface 46. The surface of terminal seat 37 continues as part of the outer surface 32 annularly horizontal from the chamfered surface 46a. Adjacent the female distal end 36, a rounded edge 52 filletly connects the female outer surface 32 to a female inner surface 34. The rounded edge defines the perimeter of a female aperture 54.

The female distal end 36 is also adapted to be a female terminal seat 37. In one embodiment the female terminal seat 37 is a smooth surface. The smooth surface of the female terminal seat 37 is adapted to engage to the crimp terminal 18 at the crimp seat 18c. Preferably, the inner surface of the crimp terminal seat 18c slides over and around the terminal seat 37. The crimp terminal 18 may be secured the female member 22 by silver brazing or solder 21. While silver brazing or solder is preferred other conventionally known ways of attached an electrical terminal to a union are contemplated.

In an alternative embodiment, the female terminal seat 37 can have a threaded surface. The threaded surface is capable of receiving a conventional securing means, such as a nut, or other similarly threaded surface. The female terminal seat 37 having a threaded surface of the quick disconnect union 10 of the present invention is threadedly connected into the terminating end of the electrical wires 8.

Preferably, the continuous female inner surface 34 continues to extend proximally from the distal end 36 and edge 32 in an annularly horizontal and continuous manner. The female lumen 55 is defined by the inner surface 34, and the lumen 55 fluidly communicates with a male lumen 56 defined by an extending member 25 to form the continuous union lumen 16 when the union members 22, 24 are selectively mated.

The female inner surface 34 then extends to form a cavity wall 35. The cavity wall 35 comprises a vertical cavity wall 35b and a horizontal cavity wall 35a. Preferably, the cavity wall 35 extends vertically outward from the female longitudinal central axis 44 and orthogonally from the female lumen 55 to form the vertical cavity wall 35b. The horizontal cavity wall 35a orthogonally extends proximally from the vertical cavity wall 35b in a horizontal manner to define the inner cavity 33. The cavity wall 35 connects at a right angle with the terminal end 23 of the vertical flange wall 40c.

The terminal end 23 of the vertical flange wall 40c defines a receiving aperture 48. The receiving aperture 48 is in fluid communication with the inner cavity 33. The inner cavity 33 when disconnected is an empty area or hollow capable of receiving the male extending member 25 which is part of the male member 24. The female member inner cavity 33 is in fluid communication with the female member lumen 55.

The male member 24 has a continuous outer surface 60 and a continuous inner surface 61. Similar to female member 22, male member 24 has a proximal end 62 and a distal end 63. Further similar to the female member 22, the male member 24 is also generally cannular in shape.

The term proximal with regard to the male member 24 refers to the side of the male member 24 that is closer to the mating surface 27. The distal end 63 is farther from the mating surface 27. Thus, the distal end 63 of the male member 24 is located farther from the mating surface 27 when the extending member 25 is inserted into the inner cavity 33 than the male proximal end 62.

The male outer surface 60 begins at a male member flange 41 located at the proximal end 62. The male flange comprises annular tapered surface 41a, an annular horizontal surface 41b, and a second vertical flange wall 41c. The second vertical flange wall 41c extends radially inward from the edge of the flange 41 towards the male longitudinal central axis 45. Preferably, the annular horizontal surface extends distally from the proximal end 62. The annular tapered surface extends distally from the horizontal surface 41b and tapers inward towards the male longitudinal central axis 45. A male hexagonal surface 47 extends distally and is capable of receiving a conventional socket, wrench, or other known gripping member. Further, while the hexagonal region 47 has a cross section of a conventional hexagon, other geometric cross sections that would provide a way for a gripping member to grasp the region are contemplated

A threaded surface 67, having a plurality of threads 69, extends distally from the hexagonal region 47 forming a male terminal seat. In the preferred embodiment the male terminal seat is a threaded surface 67. The threaded surface 67 terminal seat is capable of receiving a conventional securing means, such as a nut, or other similarly threaded surface and connects to an end of the heating device 12 or induction coil 12a.

Alternatively, the threaded surface 67 terminal seat can have a smooth finish. The smooth finished terminal seat may be adapted to receive and connect to electrical cables that connect to the heating device 12 or induction coil 12a. The threaded surface 67 terminates at a distal edge 53. Preferably, a distal vertical wall 57 extends radially inward towards a male longitudinal central axis 45. The distal vertical wall 57 terminates and defines a male distal aperture 65. The male distal aperture 65 is integrally connected with the male lumen 56 to further make up the connected union lumen 16. The continuous inner male surface 61 preferably extends proximally and generally orthogonal through the entire length of the male member 24.

The male second vertical flange wall 41c extends radially inward from the annular horizontal surface 41b. Preferably, the second vertical flange wall 41c extends inward towards the male longitudinal central axis 45 of the male member 24. The extending member 25 meets the second vertical flange wall 43 at its terminus 28. The extending member 25 extends orthogonally or perpendicularly away from the second vertical flange wall 41c.

The extending member 25 is generally cannular in shape and is designed to engage the female member 22 by selectively mating and sliding into the inner cavity 33. The outer diameter of extending member 25 is slightly smaller than diameter of inner cavity 33. The slightly smaller diameter of the extending member 25 permits it to slide into the inner cavity 33 and mate with the female member 22. In the preferred embodiment the term slightly refers to a range preferably between 0.001 inches to 0.50 inches. However, it should be clearly understood to one in the art that other dimension are possible to achieve the mated relationship.

The extending member 25 has a continuous outer surface 68. The continuous outer surface 68 comprises an annular horizontal extending member surface 68a and a vertical extending member surface 68b. The annular horizontal extending member surface 68a extends outwardly from the second vertical flange wall 40c. The annular horizontal extending member surface 68a can have at least one annular recess 70. The annular recess 70 receives and substantially secures a seal, such as a rubber gasket 72. The embodiment shows only one annular recess 70, however other embodiments have a plurality of annular recesses.

The extending member 25 is intended to enter into the inner cavity 33 fully so that a mating surface 27 is created. The mating surface 27 is the surfaces of the members 22, 24 that engage each other when the members are selectively mated. The mating surface 27 comprises first vertical flange wall 40c engaged with second vertical flange wall 41c, annular horizontal extending member surface 68a engaged with horizontal cavity wall 35a, and vertical extending member surface 68b engaged with vertical cavity wall 35b.

Further, when engaged and mated the female flange 40 and the male flange 41 create a tongue 30. The tongue comprises surfaces 40a, 40b, 41b, and 41a when the male and female members 22, 24 are mated. To secure the union 10, the tongue 30 is inserted into and received by a groove 31 defined by a securing members 26A, 26B. When the securing member 26 is in its closed position, a tongue and groove closure secures the union 10 while the gasket 72 seals the union. The groove comprises groove surfaces 31a spaced apart and connected by annular horizontal groove surface 31b.

An alternate embodiment provides a securing member 126 comprising two semi-circular members 126A, 126B. The members 126A, 126B are rotabably pivotable between and open and closed position about pivot pin 128. Pivot pin 128 pivotally engages members 126A, 126B at an aligned end of each member 126A, 126B. Pivot pin 128 permits the members 126A, 128B to travel about directional arrow B. When engaged and mated the female flange 40 and the male flange 41 create a tongue 30. The tongue comprises surfaces 40a, 40b, 41b, and 41a when the male and female members 22, 24 are mated. To secure the union 10, the tongue 30 is inserted into and received by a groove 131 defined by a securing members 126A, 126B. When the securing member 126 is in its closed position, a tongue and groove closure seals the union 10. The groove 131 comprises groove surfaces 131a spaced apart and connected by annular horizontal groove surface 131b.

At least one first boss 126a extends from an end of first member 126A opposite the pivot pin 128. First boss 126a defines a first tightening member aperture 176a. At least one second boss 126b opposite the pivot pin 128 extends from an end of second member 126B. Second boss 126b defines a second tightening member aperture 176b. The first and second tightening member apertures 176a, 176b are aligned and receive a tightening member 129. Preferably, tightening member apertures 176a, 176b are generally U-shaped for slidably engaging tightening member 129. Tightening member 129 comprises a shaft 129a and a tightening collar 129b. Preferably, tightening member 129 is a thumb screw. Shaft 129a is preferably pivotably connected to boss 126a by pivot pin 132. Pivot pin 132 permits tightening member 129 to pivotably rotate along directional arrow C between a secured and unsecured position. Shaft 129a engages aperture 176b and tightening collar 129a may be tightened by collar surface 130 is tightened to engage boss 126b. Tightening collar 129a comprises wings 133 that extend outward from collar 129a. Wings 133 act as a lever arm to assist in a rotational tightening of member 129. Preferably tightening member 129 is a wingnut.

In operation, the male member 24 is inserted into the female member 22 along directional arrow “A” to mate the two members 22, 24. The extending member 25 slidably fits into the inner cavity 33. A seal is created by an interference fit of the gaskets 72 with the inner surface 35.

A user then secures the mated members 22, 24 by securing a securing member 26 to the tongue 30 that is created after mating. The user tightens the tightening member 129, which tightens the securing member 126 about the union 10 to ensure a proper and secure seal.

The tightening member 129 can be disconnected in a manner that is easy and fast for the user. One anticipated quick disconnect method provides a tightening member 129 made of a convention thumb screw. The thumb screw tightening member 129 is a type of screw drive fastener preferably with a tall head collar 129b and ridged or knurled sides, or a flat, extending vertical wings 133. The thumb screw tightening member 129 is intended to be quickly and securely tightened by hand, rather than requiring tools such as a screw driver which take longer to operate. Alternative and conventionally acceptable quick-connects tightening members are anticipated, by way of example and not a limitation, quick clamps, quick levers, and quick release handles.

Throughout this specification, the term quick means that the tightening member 29, 129 can be tightened or loosened by hand while still providing a secure fit. The term quick is a relative term meaning that it would be faster to loosen and remove the securing member of the present invention than it would be to use a conventional securing means that had no such tightening member 29, 129.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An induction heating system comprising:
an electrical power source;
a coolant transporting device;
an induction coil;
a power cable connecting the power source and the coolant transporting device to the induction coil; and
at least one quick disconnect union operatively connected to the power cable and one of the power source, the coolant transporting device and the induction coil.

2. The system of claim 1 wherein the union comprises:
a female member;
a male member configured to mate with the female member; and
a securing member, wherein said securing member secures the female and male members together when mated.

3. The system of claim 2 wherein the female member further comprises:
a proximal end and a distal end;
a female member flange adjacent the proximal end; and
a female member terminal seat adjacent the distal end.

4. The system of claim 3 wherein the male member further comprises:
a male member flange adapted to engage the female member flange; and
a male member terminal seat spaced apart a distance from the male member flange.

5. The system of claim 4, wherein the female member comprises:
a female inner surface which defines a female lumen, and
a female member inner cavity defined by the female inner surface in fluid communication with the female lumen.

6. The system of claim 5, wherein the male member comprises:
a male inner surface which defines a male lumen.

7. The system of claim 6, wherein the union further comprises:
a union lumen comprising the female lumen and the male lumen when the female and male members are mated.

8. The system of claim 7, wherein the male member further comprises:
an extending member that extends outwardly from the male member flange at the proximal end and defines an annular recess;
a gasket in the annular recess; and
wherein the extending member is received in the female inner cavity when the female and male members are mated.

9. The system of claim 8, wherein the extending member has an outer diameter slightly less than an inner diameter of the female inner cavity.

10. The system of claim 2, further comprising a tongue which comprises a female member flange and a male member flange which engages the female member flange, and wherein the securing member further comprises:
a first semi-circular member;
a second semi-circular member;
a groove defined by the semi-circular members adapted to engage the tongue;
a first boss extending outwardly from the first semi-circular member and defining a first tightening member aperture;
a second boss extending outwardly from the second semi-circular member and defining a second tightening member aperture; and
a tightening member adapted to selectively secure the two semi-circular members together.

11. The system of claim 10, wherein the securing member further comprises:
a first pivot pin engaging one end of each semi-circular member permitting the semi-circular members to pivot between an open and closed position;
wherein the first boss extends from an end of the first semi-circular member opposite the pivot pin wherein the first tightening member aperture is generally U-shaped;
wherein the second boss extends from an end of the second semi-circular member opposite the first pivot pin wherein the second tightening member aperture is generally U-shaped;
a second pivot pin attached to the first boss and a shaft of the tightening member, wherein second pivot pin permits the tightening member to pivotably rotate between a secured and an unsecured position.

12. The system of claim 11, wherein the tightening member is a wingnut.

13. The system of claim 10, wherein the tightening member further comprises:
a first and second boss on the first semi-circular member;
a third and fourth boss on the second semi-circular member;
wherein the first and second bosses extend outwardly from adjacent each end of the first semi-circular members and the third and fourth bosses extend outwardly from adjacent each end of the second semi-circular members, each first, second, third, and fourth boss defining a first, second, third, and fourth tightening member aperture respectively, adapted to be aligned with one of the other tightening member apertures of the other semi-circular member; and
two tightening members securing the semi-circular members together and adapted to be inserted through the aligned tightening member apertures and secured.

14. A quick connect and disconnect union comprising:
a female member defining a cavity;
a male member which comprises an extending member receivable in the cavity;
a compressible gasket which forms a seal between the female and male members when mated together in a mated position;
a securing member having a secured position and an unsecured position and adapted to secure the female and male members together in the mated position;
a union lumen defined by the mated female and male members; and wherein the union is adapted to secure a power cable comprising electrical wires, coolant, and a crimp terminal, to one of (a) a power source, (b) a coolant transporting device, and (c) an induction heating apparatus.

15. The union of claim 14, where the extending member further has
a generally cannular shape; and
an outer diameter slightly less than an inner diameter of the inner cavity.

16. The union of claim 15, wherein the securing member further comprises:
a first semi-circular member;
a second semi-circular member;
a pivot pin engaging one end of each semi-circular member permitting the semi-circular members to pivot between an open and a closed position;
wherein a first boss extends from the end of the first semi-circular member opposite the pivot pin defining a generally U-shaped tightening member aperture;
wherein a second boss extends from the end of the second semi-circular member opposite the pivot pin defining a generally U-shaped tightening member aperture;
a tightening member comprises a shaft having two ends with a wingnut threadedly attached to one end of the shaft;
a second pivot pin pivotably connecting the first boss and the shaft of the tightening member, wherein the second pivot pin permits the tightening member to rotate between a secured and an unsecured position.

17. A method comprising the steps of:
providing an induction heating system comprising a power source,
a coolant transporting device, an induction coil, a power cable connecting the power source and the coolant transporting device to the induction coil, a quick disconnect union which comprises a female member, a male member, and a securing member;
inserting the male member into the female member;
creating a seal between a gasket and an inner surface of the female member; and
securing the male and female members together with the securing member to secure the power cable to one of (a) the power source, (b) the coolant transporting device, and (c) the induction coil.

18. The method of claim 17, where the step of inserting the male member into the female member further comprises the step of:
transforming a female lumen defined by the female member and a male lumen defined by the male member into a union lumen.

19. The method of claim 17, where the step of securing the two members further comprises the steps of:
aligning a groove defined by the securing member with a tongue defined by flanges on the mated members; and
tightening a tightening member operatively connected to the securing member wherein the groove engages and secures the tongue.

20. The method of claim 17, further comprising the steps of:
turning on the power source; and
pumping coolant through the system.
